(19) United States
(12) Patent Application Publication
(10) Pub. No.: US 2010/0317090 A1
(43) Pub. Date: Dec. 16, 2010

(54) WASTE TREATMENT SYSTEM

(76) Inventor: Julian Parry, Weston-Super-Marc (GB)

Correspondence Address: INTELLECTUAL PROPERTY / TECHNOLOGY LAW, PO BOX 14329, RESEARCH TRIANGLE PARK, NC, 27709, US

(21) Appl. No.: 12/866,033

(22) PCT Filed: Feb. 10, 2009
(86) PCT No.: PCT/GB09/00369

§ 371 Date: Aug. 3, 2010

(30) Foreign Application Priority Data
Feb. 11, 2008 (GB) 0802388.9

(51) Int. Cl. C02F 3/34; B30B 15/06

(52) U.S. Cl. 435/262; 100/295

(57) ABSTRACT

A process for treating mixed waste material, said process comprising a) collecting said mixed waste in bags; b) autoclaving the bags under conditions in which the bags degrade; c) separating the material from step (b) into three fractions, a first fraction comprising liquid materials, a second fraction comprising large solid waste materials and a third fraction comprising fibrous material; d) subjecting the third fraction of step (c) to a remediation process such as an aerobic digestion; and e) recovering the product of step (d). Use of aerobic digestion as a drying process for materials, and certain apparatus for use in the process are also described and claimed.

The present invention relates to a waste treatment system, and to novel apparatus used in the system.

The European Landfill Directive EC 199/31 has gradually forced local waste authorities to face the legal requirement to divert bio-degradable waste from landfill. At the same time there is wide concern related to the effect that long cycle carbon dioxide obtained from burning fossil fuel is having on climate change.

A major problem with household waste is the great diversity of materials found there, ranging from organic food waste to non-degradable solids that are generally inorganic such as metals or minerals. These are generally contained within plastic-bags that are not opened prior to disposal. These can provide a real problem for subsequent treatment and recycling, since they restrict separation of materials and access of treatment reagents or resources to the waste material contained within.

The present invention represents a novel amalgamation of techniques and technologies that addresses these problems in a consolidated fashion. The invention allows the issues with respect to waste management and in particular in the treatment of waste from non-segregated sources to be addressed efficiently and with the option of carrying these out in an environmentally friendly manner.

According to the present invention, there is provided a process for treating mixed waste material, said process comprising

a) collecting said mixed waste in bags;
b) autoclaving the bags under conditions in which the bags degrade;
c) separating the material from step (b) into three fractions,
i) a first fraction comprising liquid materials,
ii) a second fraction comprising large solid waste materials and
iii) a third fraction comprising fibrous material;
d) subjecting the third fraction iii of step (c) to a remediation process; and
e) recovering the product of step (d).

By operating the autoclave under conditions at which the bags degrade, mixed waste is released and made freely accessible for subsequent treatment. Thus they may be readily separated into materials that may undergo remediation and others that may be recycled using different procedures.

Suitably the bags used in the process may be made of woven cloth paper or plastic which may be biodegradable. In particular the bags are of biodegradable polyvinyl alcohol polymer such as that described in WO2004/046229 (the Polyval Patent application), the content of which is incorporated herein by reference. However, bags made of other plastics and biodegradable materials may be used in the process.

In a particularly preferred embodiment, the bags are gas permeable. This is particularly advantageous if for instance they are collected and stored prior to processing. In general, some storage will be necessary or desirable in order to collect the waste on a timescale that differs from the timescale of treatment. If they are stored under aerating conditions, where air or oxygen under pressure greater than ambient pressure, is pumped into a container in which they are stored, for example through a piped network such as that described in the SBS patents described in more detail below, then odours are minimised as no anaerobic digestion occurs. The air or oxygen is able to penetrate the bags to ensure that the waste itself remains aerated.

A suitable collection regime will depend upon the circumstances and the resources available. However, a possible collection regime for domestic rubbish would involve collection by area using for example, electrically powered vehicles. In particular, trailers may be used to collect suitable bags that may be supplied to households for the purpose, attached to tugs. The trailers act as temporary storage containers for the bags.

When the trailers are sufficiently loaded, they may be delivered to a designated relay point or directly to the processing plant. At the relay point the trailer may be detached from the tug and left to be collected by other vehicles, designated for the purposes of this invention as a shunter vehicle, which may be operating on a different timescale. A shunter vehicle may be any vehicle capable of drawing and/or carrying a plurality of filled trailers from the relay point directly to the processing plant or to a transfer station.

A transfer station is any location designated and equipped to allow the contents of any trailer to be deposited by any suitable means from any trailer into any suitable means of larger scale transport including but not exclusively a road worthy lorry or railway wagon by which means of transport the bags are delivered to a processing plant.

When the bags arrive at the processing plant, they are unloaded into the processing plant by any suitable means including but not exclusively for example using mechanical means of tipping up the trailers with or without the tugs attached, so that the bags are discharged onto a conveyor belt system. The bags are either taken directly for treatment or to a suitable storage container or silo where they are suitably stored under aerating conditions as described above.

Ultimately the bags of waste are conveyed to an autoclave, by any suitable means including but not exclusively a conveyor belt delivery system, any vacuum system or any appropriate bucket lift conveyor system.

Step (b) is carried out in an autoclave, capable of being operated under conditions in which the biodegradable bag will dissolve or disintegrate. Bags are loaded into the autoclave which is then operated at the required conditions. For example, the autoclave is operated so that the bags are exposed first to reduced pressure, for example from 0.1 bar or less, and then to gas in particular steam at an elevated pressure and temperature. A typical regime would involve, for example, the pressure in the vessel being reduced from ambient air pressure to a vacuum of 0.1 bar then raised to from 2-10 bar with steam at temperature in the range of from 100-200° C. Under these conditions, any sealed plastics food containers within the bags will burst releasing their contents. The introduction of steam degrades the structural integrity of the bags and dissolves for example the Polyvynil alcohol bags in the steam. Meanwhile, many of the plastic materials will contract and shrivel into condensed solid objects and particles.

The high temperatures will also effectively sanitizes the waste. It also has the effect of removing paint and labels from containers for example, food and drinks cans.

A particularly suitable autoclave device is described in British Patent Application No. 2,381,764 (the Aero-thermal patent application), the content of which is incorporated herein by reference. In particular, this device utilises circulating heating gases to heat throughout the waste material, irrespective of the position or shape of the waste.

After passage through the autoclave, the waste material being treated is separated according to its transformed physical nature, into three fractions.

The first fraction is comprised of liquid materials which will include any liquids within the waste, as well as what may be described as ‘volatile solids’ such as greases, fats and waxes dissolved or suspended in the liquid. In the conditions found in the autoclave, they will volatilize and instead of returning to a solid state, they will combine with any liquids present in the waste to form a semi-viscous liquid. This will be pourable from the autoclave.

The second fraction comprises individual solid objects, which are separated on the basis of size using a size separator. Such devices are known in the art, but a particularly effective separator for use in connection with the present invention is a ‘star’ separator as described in British Patent Application No. GB 2407469, the content of which in incorporated herein by reference. This separator utilises rotating star shaped wheels to divert large materials (forming the first fraction as defined above) and allow small material to pass through and be collected as the third fraction. The nature of the separator will therefore determine the actual size of the materials in the first fraction. The separator is operated so that the majority of the residual solids are diverted onto a first conveyor belt. Any fibrous material will pass between arms of the star wheels and be delivered to a second belt for transportation away. Generally, the third fraction is comprised of that waste that is not part of the first or second fractions. The majority of that fraction of the waste is formed of fibrous organic material suitable for remediation. However, some non-organic materials, usually in the form of small solid materials, include inorganic materials that will also pass through the star wheels. Accordingly, the third fraction may comprise a mixture of both organic and inorganic materials.

In order to eliminate small solid materials, from the organic fibre comprising the third fraction, it may be suitable in some circumstances, to subject the third fraction to a further separation step before remediation. This may for example be carried out by delivering the third fraction from the autoclave to a detritus trap. There it is mixed with liquid such as water and allowed to settle, onto perforated screens before some solid materials are removed. Solid materials with a density of less than water are removable by skimming the surface of the liquid in the detritus tank or by use of a screw conveyor, and solid materials with a density greater than water are removed though the base or side of the detritus trap.

If required, organic fibrous material may be subject to an anaerobic remediation process at this stage. Suitable anaerobic digestion processes capable of such remediation are well known in the art. In particular the fluid is allowed to ferment or digest under anaerobic conditions in the presence of suitable microorganisms and in particular anaerobic bacteria. This may be carried out in digester tanks. A particularly preferred option in this case is to employ the method and apparatus described in WO96/23054 (the BioPlex patent application), the content of which is incorporated herein by reference. In this process, fluid waste is admixed with solid waste for anaerobic digestion, after which remediated solid waste and biogases are recovered.

Biogas largely comprising methane generated during anaerobic digestion may also be collected. The methane generated may be extracted using conventional methods, for example as described in WO2006/039335, for use as fuel, for example to power elements required in the process such as the autoclave.

However, this step is optional and may depend upon the nature of the waste or the requirements of the final product. Irrespective of whether an anaerobic digestion has taken place or not, the remaining material at this stage is largely organic fibrous material in the solid phase floating in a liquid and so it is in a fluidised form. This may be passed through a macerator pump if required, to further reduce the particle size of the solids including the fibrous material.

The liquid phase can be partially removed by pouring the fluidised material onto a screen or filter through which screen or filter free flowing fluid it is freely drained away under force of gravity to leave wet residue or ‘mash’ on the screen. Suitably the screen is horizontally located within a digestor vessel. A particularly suitable digestor comprises a spherical or ball shaped container, suspended upon a pair of hollow gimbals, through which liquid may be pumped. The spherical container is therefore rotatable about a single horizontal axis. The perforated screen is suitably circular in plan, and so may be held within the spherical or ball shaped container.

This freely drained ‘mash’ remaining on the screen or filter may be further drained using a compression device applied to the surface of the mash with force in order to squeeze more liquid out through the screen upon which it was originally poured.

In the particular embodiment, the compression device comprises a compression plate, arranged within the rotatable spherical container surrounding the screen, and arranged to compress material in the vessel upon rotation of the container. The compression plate depends from the spherical container, and as the container rotates, the plate moves towards the screen applying pressure thereto to the mash which is retained upon the screen. By these means further fluid is ejected from the mash and by so doing the moisture content of the mash is further reduced.

Such a digestor comprising said compression device is novel and forms a further aspect of the invention.

In order to further enhance the efficiency of the process, the mash is repeatedly flooded with recycled and recovered liquid which is also heated to enhance anaerobic digestion which generates further methane that may be recovered and utilised within the spherical container. The liquid is passed through the hollow gimbals.

A further means of enhancing the efficiency of the process is to utilise the liquid comprising the first fraction obtained from step (c) in a secondary recycling process. For example, this fluid may be subject to anaerobic digestion for example, as in a traditional septic liquid system, similar to those found in many foul drainage treatment systems, to form a remediated liquid and sludge. The recovered sludge is then suitably subjected to a further remediation process, for example in combination with the third fraction from step (c). In addition, any biogases produced may be collected and any methane therein may be contained collected and used for the production of energy in various forms.

The remediation process of the third fraction described in step (d) suitably comprises an aerobic remediation step. Thus the material obtained as described above is suitably delivered to a vessel or silo for aerobic remediation for instance as described in the British Patent Application No 2280835 and WO 99/01237 (The SBS patents), the contents of which are incorporated herein by reference. Suitably, where the waste fraction from step (d) has been subject to an anaerobic remediation step prior to step (d), the container of the anaerobic digestion vessel may be arranged to discharge the drained fibrous organic material directly into the aerobic digestion vessel. For example, the anaerobic digestion vessel is positioned directly above the aerobic digestion vessel, for instance as described in the example hereinafter.

In a particularly preferred embodiment, the aerobic remediation is carried out by delivering resources required to remediate and change the physical and/or chemical structure of the material being remediated on a timed and repetitive basis, as described for example in the SBS patents mentioned above.

In this process, resources, including for example fluids, water born nutrients, gases, air or oxygen, and aerobic microorganisms such as fungi, bacteria, viruses and yeasts, are delivered through a piped network into the mass of material which may be contained within a suitable container such as a silo or composter. Multiple silos may be constructed together for example using modular construction techniques, so as to form a plant suitable for treating significant quantities of waste at any one time. Suitably the resources are delivered under pressure.

In particular, the microorganisms comprise white rot fungus which has been found to be particularly useful in generating rapid remediation and which processes exhibit significantly elevated temperatures within the mass. It has been found that the temperatures achievable in the mass are capable of being regulated by the designed introduction of measured resources to obtain temperatures suitable for and capable of drying the mass.

Thus the use of this aerobic remediation process as a means of drying a mash, mulch or sludge comprising organic material forms a further aspect of the invention.

The dried material is suitably removed from the silo by means of an under-cutter.

The recovered material represents a significantly transformed and compressed version or variant of the original waste material. Whilst the nature of the original waste material may mean that this not suitable for use as landfill or use as a compost beneficial to the land, it is generally dry enough to be used as fuel to generate power. As part of the overall process this material may be subjected to a gasification procedure as is known in the art, for example as illustrated in WO 01/96501 and many others.

During this process, solid carbonaceous and organic material is converted to a flammable gas, which may be burnt in a conventional power generation plant. Power generated in this way may be used in any capacity including being fed into the National Grid, but in particular, it may be used to operate the system of the invention, and in particular may be used to power the autoclave used in step (b).

In this way, the system of the invention provides a particularly environmentally friendly and efficient means of waste treatment.

Therefore embodiments of the present invention, by eliminating bio-degradable waste from the original waste stream, so that little or none is consigned to landfill and by recycling recovered solid wastes so that such waste may be otherwise used, maximises the beneficial environmental effect of the process.

In another benefit to the environment, the second fraction from step (c) may be subject to a recycling procedure to segregate and recover, but not exclusively, metals, glass and plastic therefrom. Such processes include conventional magnetic separation procedures to recover ferromagnetic materials or the use of eddy current separators to extract materials such as aluminium. These materials may then be recycled. Plastic waste obtained at this point or elsewhere in the process, for example, that recovered from the detritus tank described above, may be, using certain technologies be catalytically converted to fuel oils for example, as is known in the art, for example from the Vulcanes group (www.vulcanes.com).

The process of the invention is suitably controlled automatically for example using a computer control system. This minimises the work involved in running the plant. Once the bags are delivered to the plant, operations such as materials handling and delivery within then plant, the shredding of segregated green waste and food waste, aeration of storage silos, transportation of the bags from storage silos to the autoclave, operation of the autoclave, separation of product emanating from any autoclave, subsequent delivery of material to remediation composters, operation of the aerobic remediation process in the composters and recovery of material from the composters may all be carried out automatically. If suitable, the control system may include feedback loops. Thus, waste may be retained within a aerobic digestion silo for a predetermined period of time, or until a certain temperature or moisture content has been reached and/or maintained within the silo for a suitable length of time to provide a substantial degree of aerobic remediation. Material may be conveyed from one apparatus to another apparatus within the plant using vacuum conveyor systems, conveyor belts, pipes, cranes, overhead transporters or other transportation media depending upon the nature of the material, in accordance with conventional design principles.

All in all the process of the present invention provides the basis of an efficient, environmentally friendly, integrated system for handling a variety of wastes including that from households, municipalities, commerce or some industries.

### DEFINITION OF TERMS

As used herein, the following definitions apply to terms used in this specification.

| Term | Definition |
|---|---|
| Aerobic composting | A process in which organic matter is bio-degraded in the presence |
| | of oxygen that is delivered throughout the organic matter either by |
| | natural aspiration, assisted by fans, or in the form of compressed |
| | air. |
| Anaerobic digestion | A process involving the breakdown of organic matter by |
| | anaerobes being microbial populations that operate generally in |
| | the absence of oxygen for example as described in WO96/23054 |
| | (the BioPlex patent application). |
| Autoclave | A pressure vessel device capable of holding materials including |
| | waste materials whilst either vacuum or high pressure steam is |
| | applied as described for example in British Patent Application No. |
| | 2,381,764 (the Aero-thermal patent application). |
| Bio-degradable bags | A re-useable enclosure, open at one end, made of a flexible |
| | material that is susceptible to degradation by exposure to heat and |
| | moisture. |
| Collection service | Any service provided to the producers of waste by operatives |
| | appointed for that purpose by the local waste authority or any |
| | others concerned with the management of wastes. |
| Composter | A singularity or plurality of silos dedicated to the reception of |
| | materials capable of remediation by aerobic digestion treatment as |
| | described for example in the WO99/01237 and GB2280835 (the |
| | SBS patents) |
| Detritus trap | A tank, which is designed to retain fluids, composed of water |
| | containing suspended organic solids in which inorganic or other |
| | solids with a bulk density greater than one may be trapped, |
| | retained, and accumulated for periodic removal. |
| Digestate | The organic output pumped from the detritus tank, which has |
| | optionally been forced through a macerator pump, to prepare it for |
| | digestion (anaerobic or aerobic). |
| Digestion ball | Part of a spherical digestion device forming an aspect of the |
| | invention and developed to extract liquid from a digestate or |
| | mash. |
| Digestion pan | A device for the heating of a mixture of mash and water under |
| | anaerobic conditions for the purpose of extracting biogases and |
| | fluids including methane which may be generated as described for |
| | example in patent WO2006/039335. |
| Mash | The output of an autoclave, being a mixture of organic fibres and |
| | solids including inorganic entities. |
| National Grid | The main electrical distribution system installed across the whole |
| | of the UK operated by the Regional electricity distribution |
| | companies. |
| Polyvinyl alcohol | Is a bio-degradable material capable of manufacture in accordance |
| composition film | with WO 2004/046229 (the Polyval Patent application). |
| Relay point | A geographically defined location assigned for the interchange |
| | collection and delivery of trailers used for the purposes of the |
| | present invention |
| Remediation | A process in which waste and in particular organic waste, is |
| | treated so as to change the physical or chemical nature of the |
| | composition to render it more environmentally acceptable. |
| SBS process | A process of aerobic composting associated with the use of |
| | compressed air and other key resources as described in the SBS |
| | patents |
| SBS Patents | WO99/01237 and patents derived therefrom and GB-B-2280835 |
| SBS storage silos | Silos made of corrosion resistant materials into which waste such |
| | as bagged waste including but not exclusively waste held in bio- |
| | degradable bags, may be placed and kept fresh by the injection of |
| | compressed air using for example a piped network similar to that |
| | described in the SBS patents. |
| SBS treatment silos | A composter as defined above intended for the remediation of |
| | compostable organic materials by means of aerobic digestion and |
| | degradation. |
| Shunter | A suitably powered roadworthy vehicle for example, powered by |
| | an electric motor, an internal combustion engine or horsepower |
| | that is used for the collection of materials and that may for |
| | example travel at a speed of more than three approximately two |
| | miles per hour whilst capable of both towing, moving and |
| | carrying the self weight of the trailer and the shunter vehicle itself |
| | plus the combined weight a of two trailers fully loaded with |
| | collected waste where each trailer is capable of carrying a payload |
| | of for instance not less than six tonnes. |
| Star-cycle separator | A materials separation device as described in British Patent |
| | Application No. GB 2407469 (the Pearson patent). |
| Plant | The physical embodiment of the assembled technologies, in |
| | whole or in part, contrived to provide a means of managing and |
| | disposing and recycling wastes. |
| Transfer Station | A geographically defined location designated for the purpose of |
| | acting as a waste reception centre capable of receiving collected |
| | waste held within collection trailers and shunter vehicles and |
| | providing a place where the transfer of that waste into alternate |
| | means of transport can take place prior to movement to a waste |
| | treatment plant operating the process of the invention. |
| Tug | A roadworthy vehicle powered by an electric motor, an internal |
| | combustion engine or horsepower that is used for the collection of |
| | materials at a speed of generally less than five miles per hour |
| | whilst towing the combined weight a fully loaded trailer that is |
| | itself capable of carrying a payload of not less than six tonnes. |
| Under- cutter | A device designed for the unloading of composted materials |
| | leaving a composter or silo as illustrated in the SBS patents. It |
| | may comprise a powered rotatable device fitted with blades, |
| | adjustable cutters or helical flutes that sits at the base of the silos, |
| | which can be forcibly rotated such that the cutters, helical flutes |
| | or blades cut into the bottom of the composted waste, removing a |
| | regulated portion of that mass and allowing the portion removed |
| | access to the extraction system designed to take cut material |
| | away. |
| Waste reception centre | An installation assigned and equipped for the purpose of receiving |
| | waste materials on behalf of its operators. |

The invention will now be particularly described by way of example with reference to the accompanying diagrammatic drawings in which:

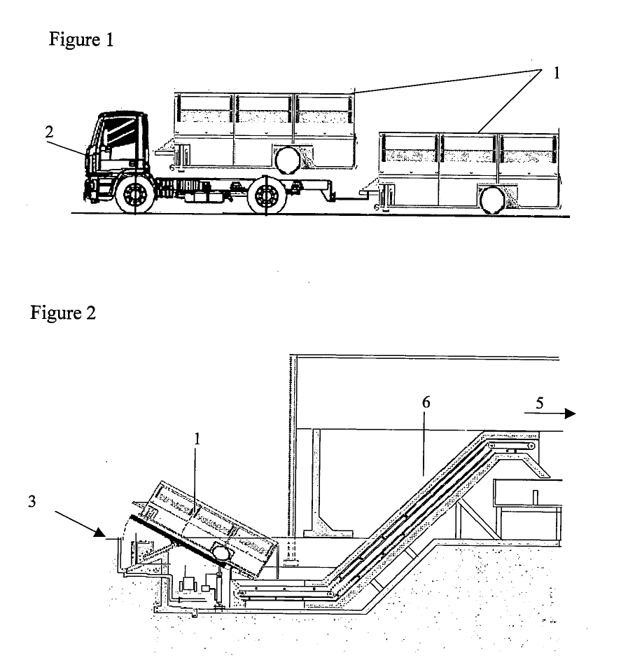

FIG. 1 illustrates a transport system that may be used in conjunction with the process of the invention;

FIG. 2 illustrates a loading scheme that may be used in conjunction with the process of the invention;

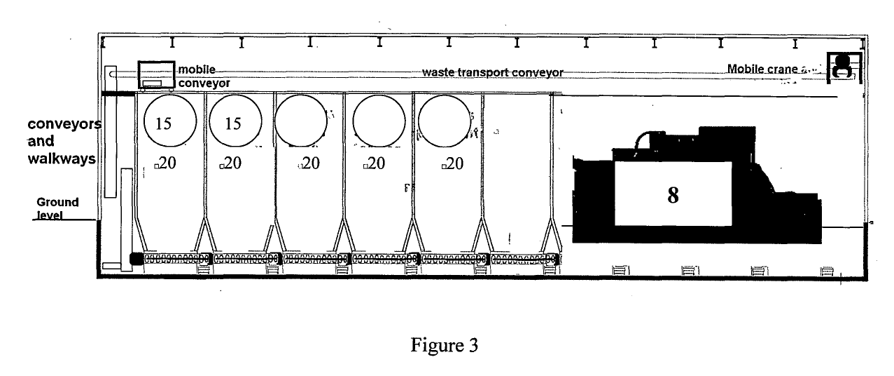

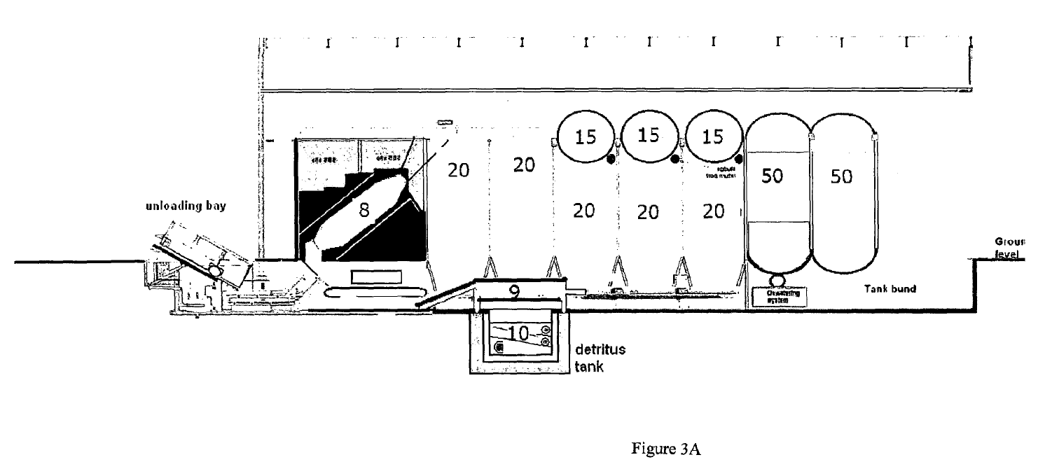

FIG. 3 is a schematic view of a longitudinal section through a plant comprising composters or silos for use in the process of the invention;

FIG. 3A is a schematic view of a longitudinal section through a further plant comprising composters or silos for use in the process of the invention, that has been modified as compared to that of FIG. 3 and shows further apparatus including the loading scheme of FIG. 2;

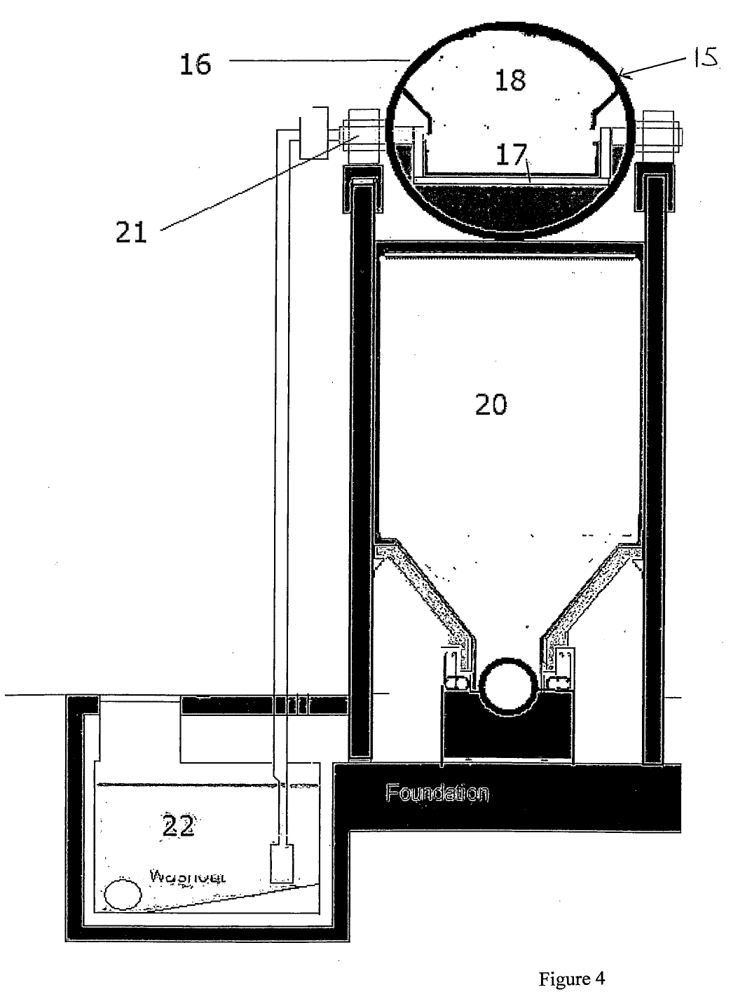

FIG. 4 is a schematic cross section through an apparatus for carrying out the process of the invention;

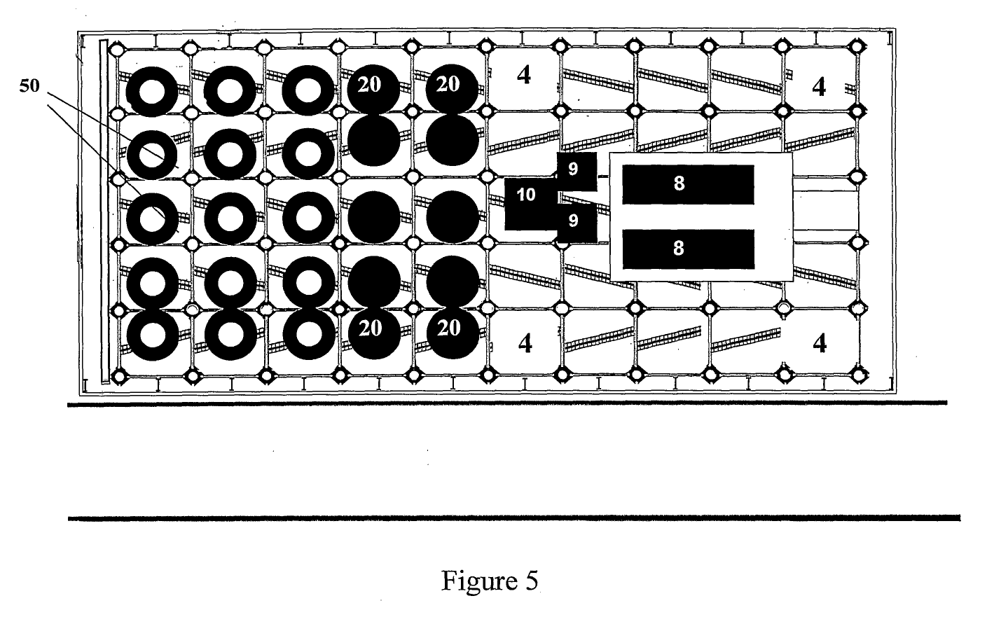

FIG. 5 is a schematic plan view of the composter of FIG. 3A;

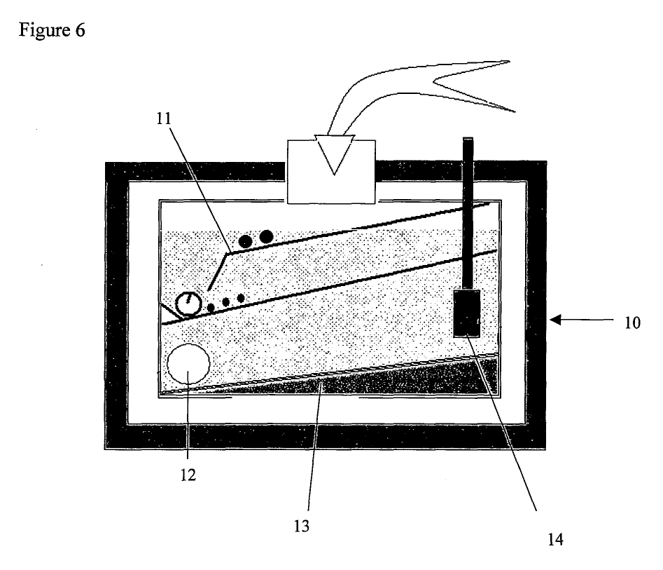

FIG. 6 is a schematic section through a detritus tank that may be used in conjunction with the process of the invention;

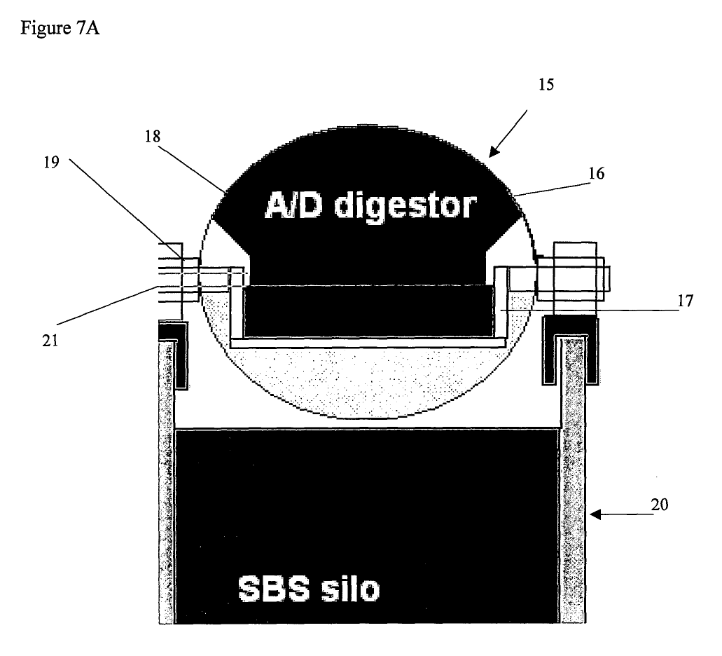

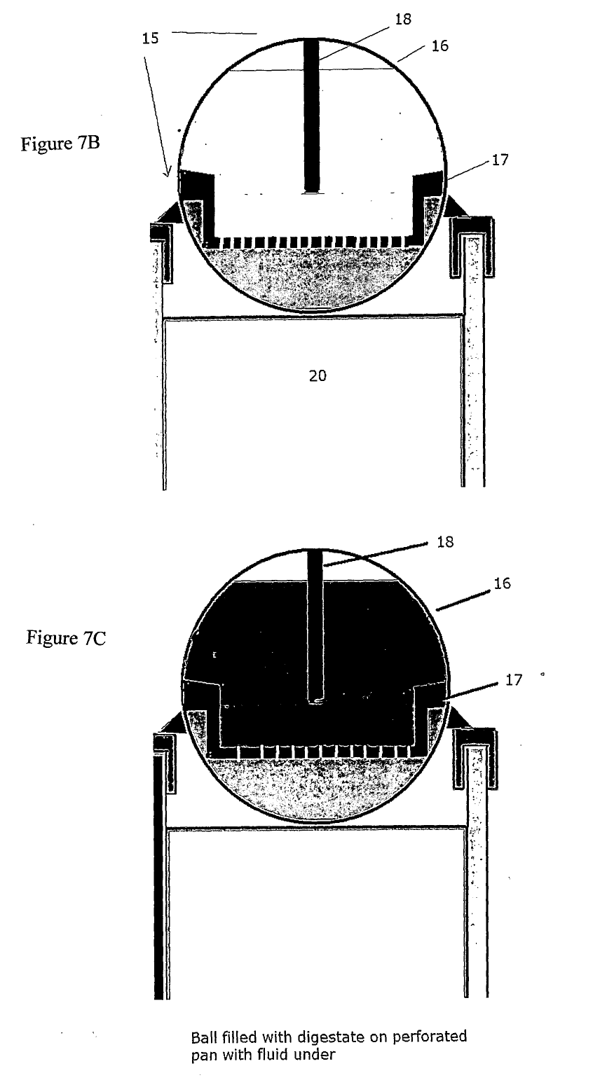

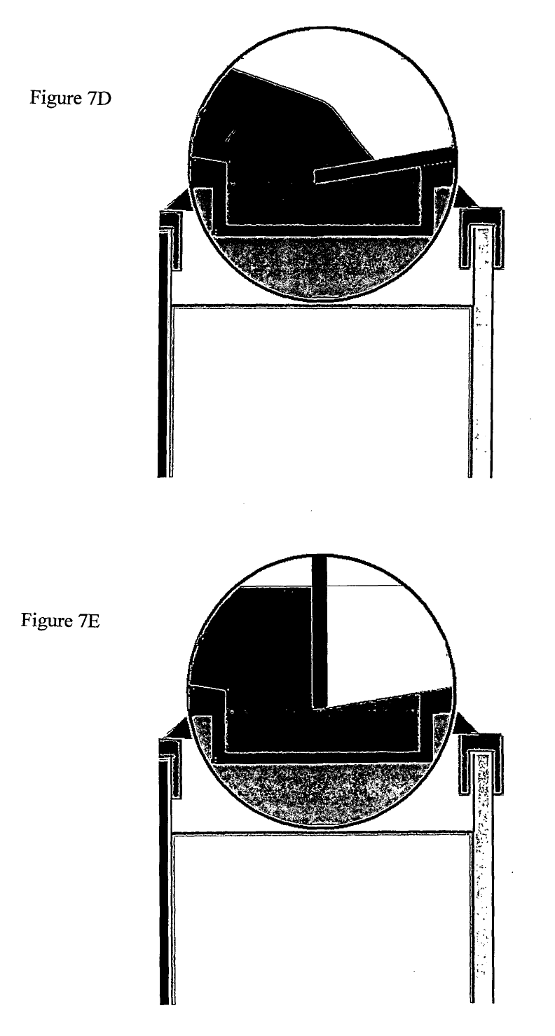

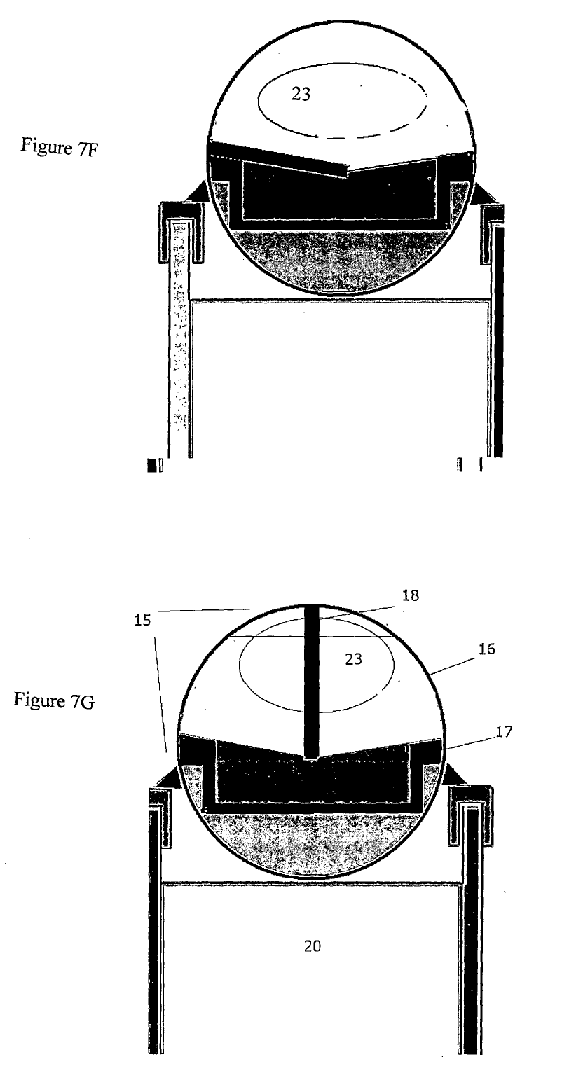

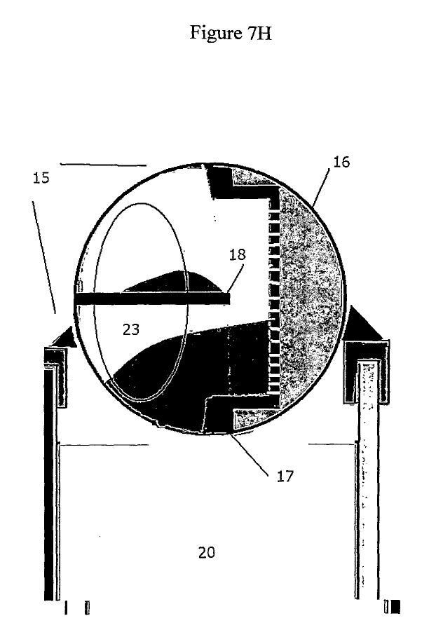

FIG. 7 is a series of schematic sections through an anaerobic digestion pan arrangement that may be used in conjunction with the process of the invention and incorporates a device for compressing waste according to the invention, in which FIG. 7A is a schematic front section through the digestion pan, and FIGS. 7B-7H are side sections showing the operation of a compression device of the invention; and

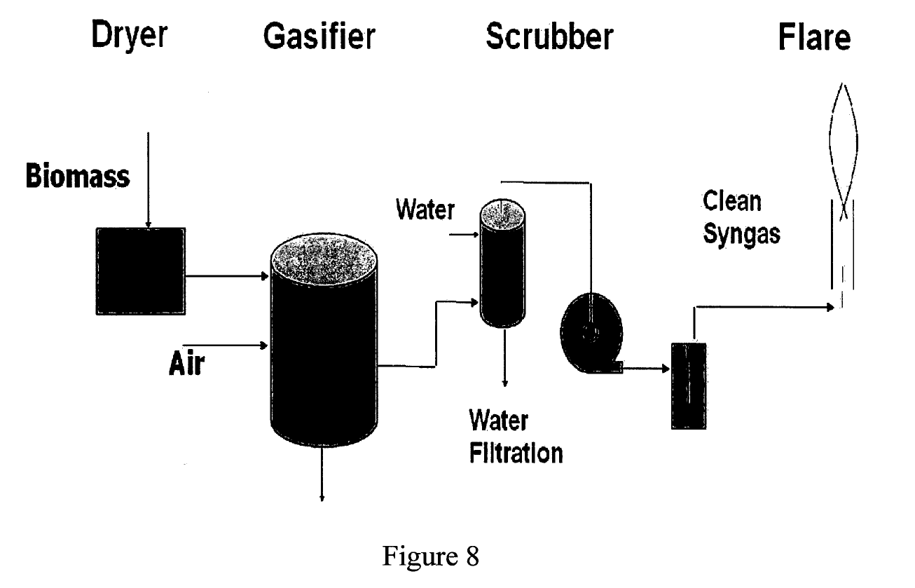

FIG. 8 is a schematic illustration of a gasification process that may be applied to the product of the process of the invention to generate energy therefrom.

The present invention is concerned with a process designed to facilitate the recycling of waste materials produced form household, municipalities, commerce or some industries in which organic bio-degradable waste materials are segregated from inorganic materials in a way which facilitates the reduction of organic wastes to a fuel and recycles the majority of inorganic wastes.

The process begins with waste producers such as but not exclusively households, arranging for their wastes to be assembled in bags in particular bio-degradable bags, for example, 65 litre bags made of a polyvinyl alcohol composition film as defined above, ready for periodic collection by contractors appointed for the purposes of waste collection.

The bags are placed into trailers (1) pulled by tugs which travel door to door in search of such waste. There is no need to crush the bags at this point and so the trailers may be simple in design.

When the trailers are suitably loaded they are deposited at a relay point. The collection service, replace the filled trailer with an empty second trailer of similar design. The second has been deposited at the relay point at a pre-determined time ready for use by the collection service.

The filled trailer is now collected for example by a shunter capable of removing the said trailer from the relay point to a waste reception centre or transfer station. The shunter may carry more than one trailer, for example it may comprise a lorry designed to carry containers or vehicles and which is made capable of carrying four or more trailers or it may comprise a lorry, articulated or rigid, (2) (FIG. 1) capable of carrying a trailer (1) on its trailer and-towing a second.

Upon arrival at the waste reception centre (FIG. 2) the trailer (1) is emptied into an industry reception system (3) which tips up the trailer so that the contents are delivered to a conveyor (6). This in turn delivers the waste into a storage system in the direction of arrow (5) involving a plurality of storage silos (4) (FIG. 5) fitted with aerating equipment such as described in the SBS patents.

The storage facility is of sufficient size to buffer the flow of excess wastes derived of seasonal variations in waste flows provided by waste producers. Waste is taken from the storage facility on a regular basis; typically once every three hours in loads of 15 tonnes or more depending upon the size of autoclaves (8) that have been installed in the plant.

Waste withdrawn from the storage facility is placed in an autoclave (8) for treatment. Alternatively, as shown in FIG. 3A, the waste is delivered directly from the trailer by way of a conveyor to the autoclave (8).

The autoclaves (8) are operated suitably (for example in pairs) in accordance with manufacturers instructions and after an appropriate period, (which may about two and a half hours) it releases the waste in a degraded form known as ‘mash’.

The bulk density of the mash has risen from 0.26 to approximately 1.1. The moisture content has risen from 20% to just over 90%. The temperature of the mash is approximately 80 degrees centigrade. The in process operating temperature went to 160 degrees centigrade and the waste is sufficiently sterilised to satisfy the Part 2 of the Animal By-products Order published under English Law.

Upon being unloaded from the autoclave the mash is immediately consigned to a star-cycle separator (9).

The star cycle separator (9) divides organic waste and small objects from the larger inorganic entities contained in the mash.

The larger inorganic entities are discharged onto a conveyor belt to be conveyed to a materials recycling facility for recycling involving known technologies such as magnetic separation, eddy current separators, and others.

The mixture of organic matter and smaller inorganic entities are discharged separately onto another conveyor belt to be conveyed to a detritus trap (10) (FIGS. 3A and 6).

The mixed waste is poured into the detritus trap (10) together with water. Those entities with a bulk density of less than one are mostly small balls of plastic but can also include timber and very small sealed enclosures and similar entities which displace more mass then their self-weight. These entities are all removed from the detritus trap (10) using for example a screw conveyor (11) and sent to landfill.

Any pieces of plastic are the remains of plastic containers that having past through the autoclave process have changed shape and reduced in overall dimension. The detritus trap (10) provides a means of removing all these floating objects for processing for example into fuel.

Those small solid masses such as inorganic entities with a bulk density greater than one such as stones and bottle tops are caught in a mesh screen or similar and removed daily before consignment to landfill as inert washed material. Alternatively, the detritus trap (10) may be provided with an inclined base (13) of concrete, so that the heavy entities are directed to a washout station (12).

The organic matter is pumped out of the detritus tank (10) using for example a maceration pump (14), on into for example a fluid reception tank (22) (FIG. 4) where it is agitated by jet action for instance using spargers, as described in principle in WO96/23054.

The organic matter is then macerated and pumped as a digestate from the tank (22) through a pipe (21) onto a perforated tray (17). The perforated tray (17) is part of an anaerobic digestion pan (15). The digestion pan (15) further comprises a rotatable spherical container or digestion ball (16) (FIG. 7) made of water resistant or inert material such as stainless steel, galvanised steel or glass reinforced plastic. These anaerobic digestion pans (15) are mounted on top of the composters (20) (FIG. 3).

Inside the digestion pan (15), the perforated tray (17) is mounted and fitted with a moderately fine mesh screen with a mesh size of less then 20 mm which acts as screen and drain for the digestate. The tray is circular in plan and fits a small circle within the spherical ball (16) (FIGS. 7A and 7B). The digestate is pumped into the digestion pan (15) so that it essentially fills the area above the perforated tray (17) (FIG. 7C) with fluid draining through.

A pressure plate (18) is provided inside the ball (16) and arranged so that rotation of the outer ball (16) places the pressure plate (18) in close contact with the drained digestate mass causing yet more fluids to be force out and through the mesh screen (17).

The pressure plate (18) of a strong rigid material occupies the majority of half of a great circle through the spherical ball (16) (FIG. 7A, 7B) is securely fixed or bolted into the assembly such that it hangs from the top of the spherical ball (16) with the long straight edge spanning between the gimbal support points or bearings (19).

The bearings (19) supporting the spherical digestion pan (15) are engineered such that the perforated tray (17) may be held in a static horizontal plane whilst the spherical ball (16) is rotated about its axis defined by the position of the gimbal bearings (19).

When the spherical ball (16) is rotated about its gimbal bearings in a first direction, the plate (18) moves with it and increasingly impinges on the mash stored on one side of the tray (17) and thereby squeezes the mash to remove fluids from the voids ratio (FIG. 7D) of the mash. Rotation of the spherical ball in the opposite direction will ensure that the mash deposited upon the other side of the tray (17) is also compressed (FIG. 7D and FIG. 7E).

The spherical ball (16) of each digestion pan (15) is usually but not exclusively made in a minimum of four pieces. They are smooth on the inside and connected into a whole sphere by means of external flanges bolted together.

The fluids from the digestion pan (15) are drained off through a piped network to a plurality of storage tanks (50) each interconnected to another tank (50) by a dual piped network designed to conduct the fluids into and out of each such tank.

Within the digestion pan (15) and the tanks (50) (FIG. 5) anaerobic bio-digestion causes biogas to be formed, which is then collected and from which methane may be abstracted for collection and use in, but not exclusively, an internal combustion engine linked to electrical generation. Hot water may be supplied to the digestion pan (15) for example through the pipe (21) in the bearing (19) to promote methane production during the process.

All fluid removed from the mash is drained by gravity through the pan and the via a piped network connected to the anaerobic storage tanks (50). The discharge may also be effected by pump or symphonic action.

The digestion pan (15) also comprises a door or sealable opening (23) in the perimeter of the ball (16) which may be mechanically and remotely operated by electrical, compressed air or hydraulic means. This opening is normally sealed during the digestion period. The operation of the digestion pan (15) is computer controlled. A computer system that also controls other elements in the process including the operation of the SBS process may be extended to control the actions of the digestion pan (15).

The computer system is adapted to operate the mechanical opening of the door and keep track of the position of the door (23).

The computer system may also measure temperatures within the digestion pan (15) and record the performance of the digestion process as well as forcing and controlling rotation of the pan during the emptying process.

When the mash has been sufficiently drained of fluids, plate (18) is returned to the upright position (FIG. 7G) and the whole digestion pan (15) sphere including the tray (17) and mesh screen is rotated (FIG. 7H) until that the tray (17) and mesh screen is inverted to a position centred above the open door (23). As the door (23) opens, the contents are discharged directly into the composter (20)

The rotation of the spherical pan causes the digestate to fall directly into a composter (20).

At this point, the digestate may have a temperature approaching 60 degree centigrade.

Aerobic treatment is then applied in the composter (20) for example in accordance with the SBS process. During this time, the resources needed to provide aerobic digestion including air or oxygen, an innoculum of nutrients dissolved or suspended in water, and microorganisms including for instance where necessary white rot fungus, are administered via a piped network provided within the composter at timed and regular intervals. In general, a suitable retention time for the material within the composter is about three weeks. During this time the digestate dries to obtain a moisture content of around 22%.

At this point the treated organic waste is unloaded by means of an under-cutter into a conveyor system and may be sent for further drying. Suitably, any energy required at this stage may be generated from the product still in aerobic process.

In particular, the dry organic waste may be subject to gasification, for example using a conventional process as illustrated schematically in FIG. 8. This generates methane and hydrogen that may be burnt to generate steam or generate electricity by other means which are part of the known art.

Ancillary plant may be suitably located in the under-croft to the composter silos (25) (FIG. 4).

The gasified waste turns to a dry ash which may be removed mechanically for use in products related to building material manufacture.

The steam generated by the burning methane and hydrogen is used for a plurality of purposes including but not exclusively

1. Operation of the autoclave processes.

2. Electrical generation.

Methane made available by anaerobic digestion processes may additionally be-used but not exclusively, for the generation of electrical energy for consumption within the plant or for export.

Any electrical energy generated by any means within the plant may be made available for the operation of the plant. Excess electrical energy may be exported from the plant to other consumers including, but not exclusively, the National Grid.

The composted output (from mixed household and commercial waste) is unlikely to be fit for use on field or furrow due to the significant opportunity for cross-contamination with household and commercial cleaning products.

The amount that is eventually burned, pyrolised or otherwise roasted in the absence of air amounts to about 25% of the original mass. The system avoids placing metals and other incombustible materials into this part of the energy release process.

By these means hereinbefore described, commercial, household, municipal and some industrial wastes may be largely recycled either as energy or raw materials whilst avoiding the deposit of biodegradable wastes into landfill.

A process of the invention is being developed under the name Joint Technologies Protocol (JTP).

1. A process for treating mixed waste material, said process comprising:
a) collecting said mixed waste in bags;
b) autoclaving the bags under conditions in which the bags degrade;
c) separating the material from step (b) into three fractions, a first fraction comprising liquid materials, a second fraction comprising large solid waste materials and a third fraction comprising fibrous material;
d) subjecting the third fraction of step (c) to a remediation process; and
e) recovering the product of step (d).

2. A process according to claim 1 wherein the first fraction from step (c) is subject to an anaerobic digestion to form a liquid and a sludge, and subjecting the sludge to a remediation process.

3. A process according to claim 2 wherein the sludge is added to a third fraction from step (c) for remediation.

4. A process according to claim 1 wherein the bags comprise a bio-degradable polyvinyl alcohol polymer.

5. A process according to claim 1 wherein step (b) is carried out in an autoclave operating so that the waste is exposed first to a vacuum and then to steam at an elevated pressure and temperature.

6. A process according to claim 5 wherein the elevated pressure is in the range of from 2-10 bar or atmospheres and the elevated temperature is from 100-200° C.

7. A process according to claim 1 wherein the remediation process comprises an aerobic remediation step.

8. A process according to claim 7 wherein aerobic digestion carried out by delivering resources required to remediate and change the physical and/or chemical structure to material being digested on a timed and repetitive basis.

9. A process according to claim 8 wherein the resources are delivered through a piped network, and are delivered under pressure.

10. A process according to claim 8 wherein the aerobic digestion is carried out in the presence of microorganisms comprising white rot fungus.

11. A process according to claim 1 wherein the product of step (e) is dried and the dry product burnt as fuel.

12. A process according to claim 10 wherein fuel is burnt to generate power that is used to operate an autoclave used in step (b).

13. A process according to claim 1 wherein prior to step (b), the bags are stored under aerating conditions.

14. A process according to claim 1 wherein prior to step (d), the said third fraction is subject to a separation process in which it is mixed with liquid and held in a detritus trap, to allow solid materials to be removed therefrom.

15. A process according to claim 14 wherein solid materials with a density of less than water are removed by skimming the surface of the liquid and solid materials with a density greater than water are removed through the base of the detritus trap.

16. A process according to claim 1 wherein prior to step (d), the said third fraction is subject to an anaerobic digestion process.

17. A process according to claim 1 wherein liquid is removed from the said third fraction just prior to step (d).

18. A process according to claim 17 wherein the liquid is removed using a compression plate, arranged within a rotatable container surrounding a vessel, and arranged to compress material in the vessel on rotation of the container.

19. A process according to claim 17 wherein recovered liquid is allowed to ferment and methane recovered therefrom.

20. A process according to claim 1 wherein the bags are collected in batches and stored in containers before delivery to a processing location.

21. A process according to claim 1 wherein the said second fraction from step (c) is subject to a recycling procedure to recover metals therefrom.

22. A device for removing liquid from a wet solid or sludge, said device comprising a compression plate, arranged within a rotatable support surrounding a vessel, and arranged to compress material in the vessel on rotation of the support.

23. A process for drying material comprising organic matter, said process comprising subjecting said material to an aerobic remediation process.
